(19) United States
(12) Patent Application Publication
(10) Pub. No.: US 2015/0170215 A1
(43) Pub. Date: Jun. 18, 2015

(54) Digital Advertising Video Display Unit

(71) Applicant: Independent Holdings LLC, Shorewood, MN (US)

(72) Inventor: Brian McConnell, Plymouth, MN (US)

(73) Assignee: INDEPENDENT HOLDINGS LLC, Shorewood, MN (US)

(21) Appl. No.: 14/464,384

(22) Filed: Aug. 20, 2014

Related U.S. Application Data
(60) Provisional application No. 61/867,763, filed on Aug. 20, 2013.

(51) Int. Cl. G06Q 30/02; G06F 3/0484; G06F 3/0488; G06F 3/0481

(52) U.S. Cl. CPC G06Q 30/0268; G06F 3/0481; G06F 3/04842; G06F 3/0488

(57) ABSTRACT

A digital advertising video display unit in combination with a kiosk, the kiosk having an internet connection, the digital advertising video display unit being connected to the kiosk internet connection, so that the advertising display content can be updated via the internet connection.

### CROSS-REFERENCE TO RELATED APPLICATIONS

This application claims priority from provisional application No. 61/867,763 filed Aug. 20, 2013, the entire contents of which are hereby incorporated by reference.

### STATEMENT REGARDING FEDERALLY SPONSORED RESEARCH

Not Applicable

### FIELD OF THE INVENTION

This application relates generally to a touch screen display mounted to an ATM machine (or other kiosk type machine), which integrates with the internet connection of the existing kiosk and the touch screen display unit can display advertising content as consumers conduct their business with the kiosk machine.

### BACKGROUND OF THE INVENTION

Applicant has realized that advertising and marketing can be accomplished as consumers conduct routine transactions—such as at an ATM machine. ATM machines already communicate via the internet, which provides the opportunity to tap into the existing internet connection already provided to stream content to the inventive display unit.

### BRIEF SUMMARY OF THE INVENTION

A digital advertising video display unit in combination with a kiosk, the kiosk having an internet connection, the digital advertising video display unit being connected to the kiosk internet connection, so that the advertising display content can be updated via the internet connection.

The kiosk can be any device with an internet connection, but is preferably an ATM machine. The display unit is mounted to the ATM with a bracket which positions the display unit in a vertical position. The display unit includes a computer to drive a touch screen and speakers. The display unit is a touch screen computer, as is well known in the art, and includes interactive software to allow a user to conduct an electronic transaction, such as making a restaurant reservation, purchasing a movie ticket, purchasing a concert ticket and purchasing an electronic lottery ticket. The display unit software periodically polls a server to determine if advertising content needs to be updated. The display unit can be any size, but approximately 21 inches high by approximately 13 inches wide is a preferred form factor.

The advertising would preferably be for local businesses located near the kiosk machine. The interactive software could provide coupons for local businesses.

### BRIEF DESCRIPTION OF THE DRAWINGS

FIG. 1 is a front view of the display unit mounted to the top of an ATM.

FIG. 2 is a side view of the display unit of FIG. 1.

FIG. 3 is a back view with parts shown in phantom.

FIG. 4 shows the bracket in the unassembled position.

FIG. 5 shows the bracket of FIG. 4 in the assembled position.

FIG. 6 shows a side view of the bracket.

FIG. 7 shows a front view of the bracket.

FIG. 8 shows a bottom view of the bracket.

FIG. 9 shows an alternative embodiment with a composite encasement, in an exploded view and showing a footer bracket.

FIG. 10 shows a back view the bracket and display unit.

FIG. 11 shows a metal jacket screen encasement embodiment with the display unit shown.

FIG. 12 shows the back of the metal jacket encasement with the display unit installed.

FIG. 13 shows a bracket customized for Genmega and Triton ATM's.

FIG. 14 shows the bracket of FIG. 13 unassembled.

FIG. 15 shows a bracket for Hyosung, Diebold, NCR and other ATM brands.

FIG. 16 shows the bracket of FIG. 15 unassembled.

### DETAILED DESCRIPTION OF THE INVENTION

While this invention may be embodied in many forms, there are described in detail herein specific embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

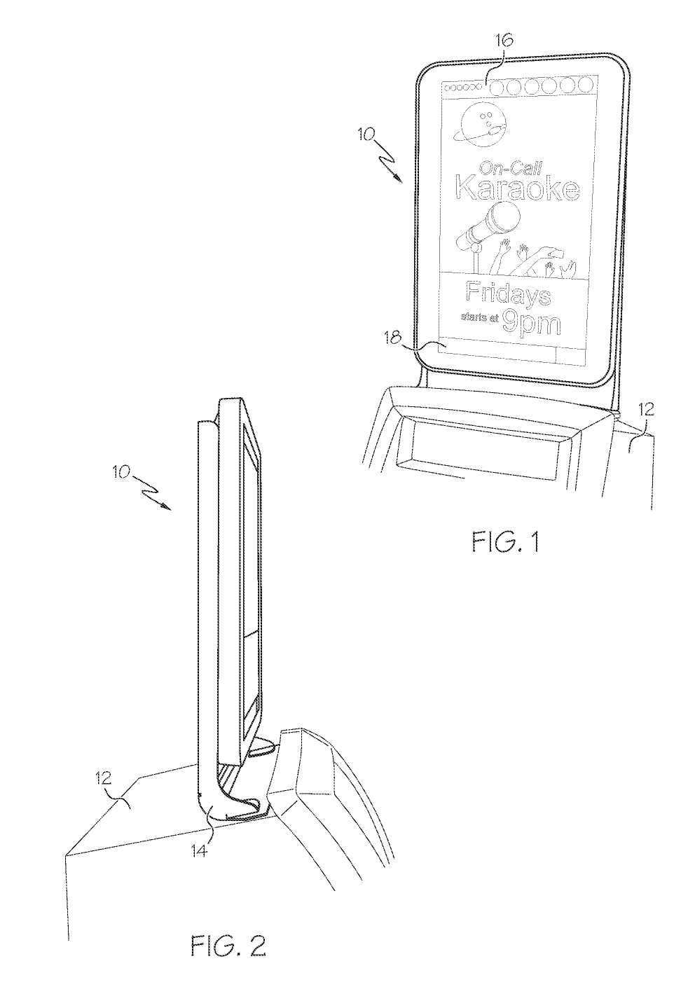

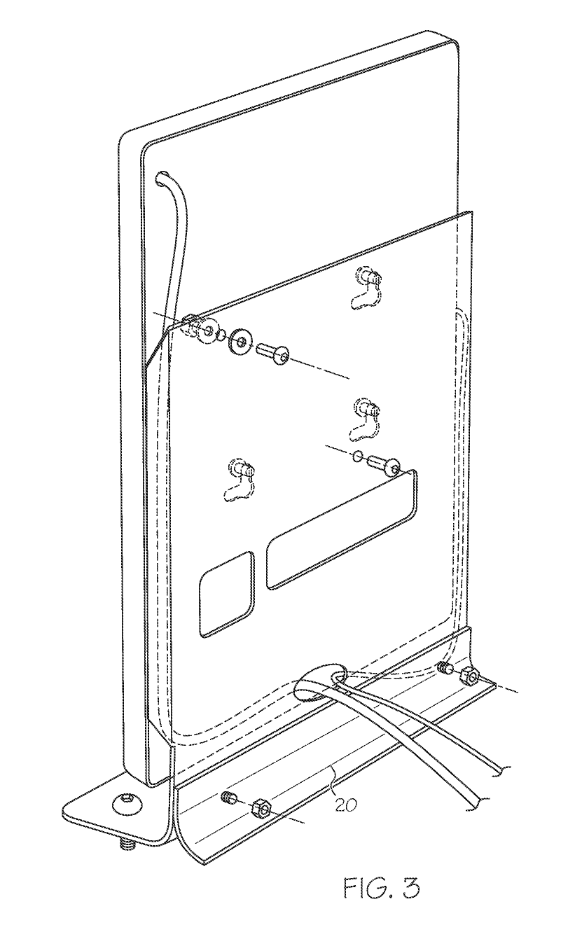

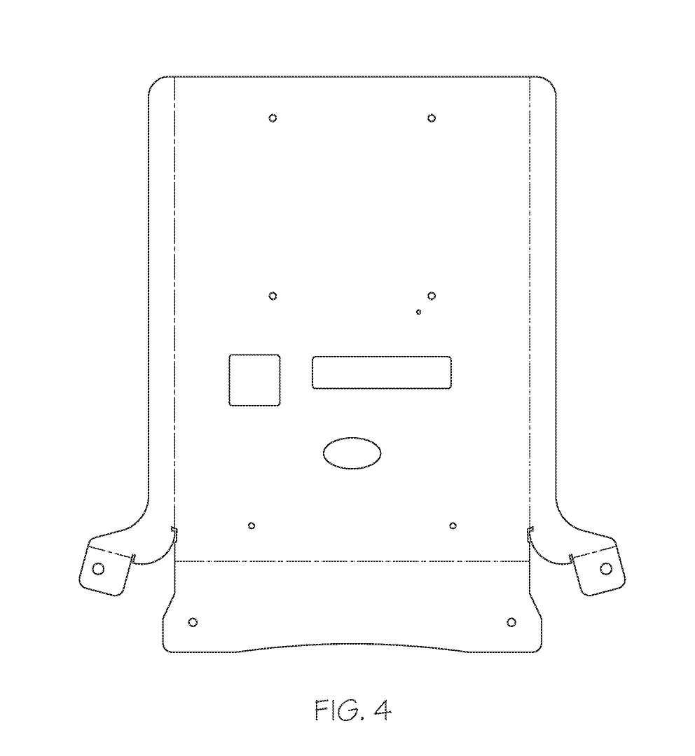

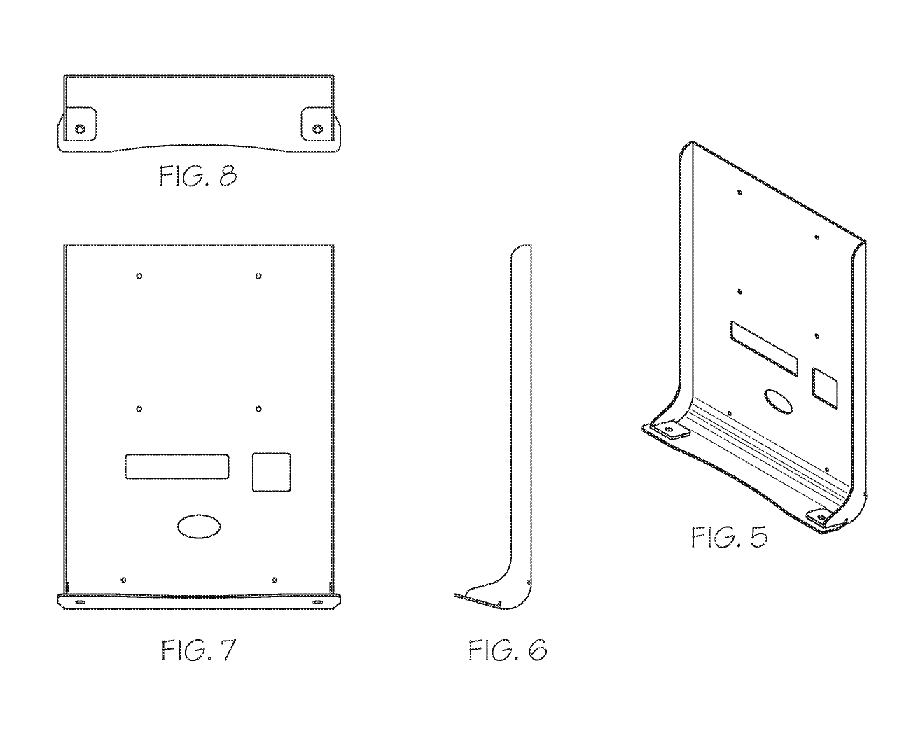

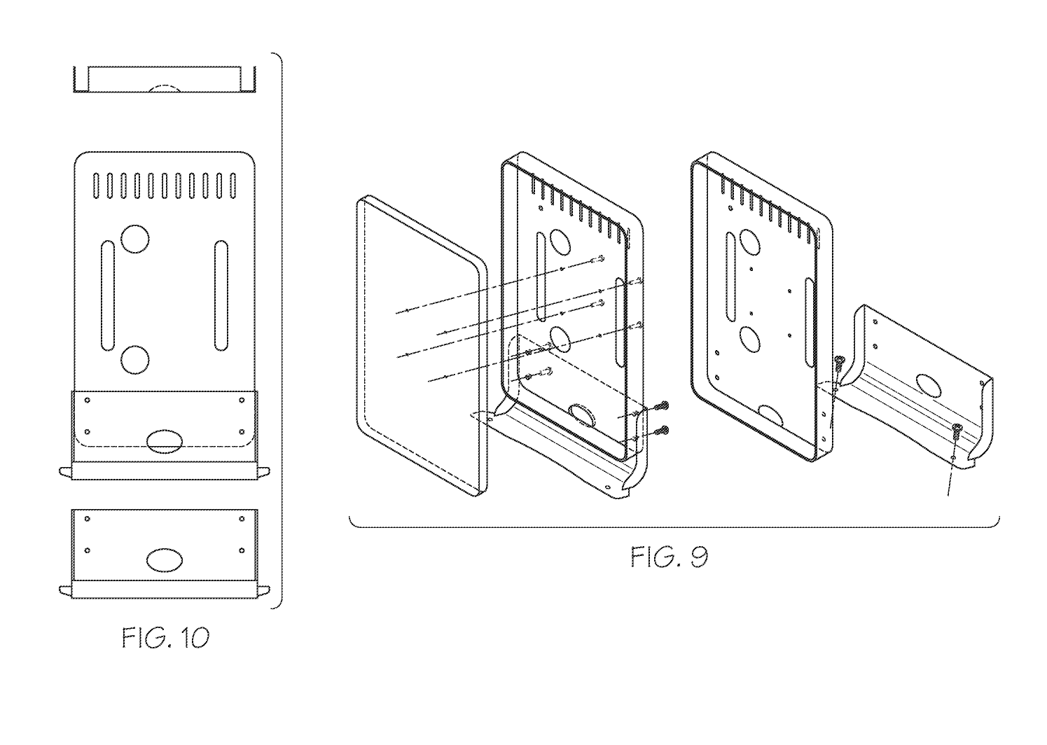

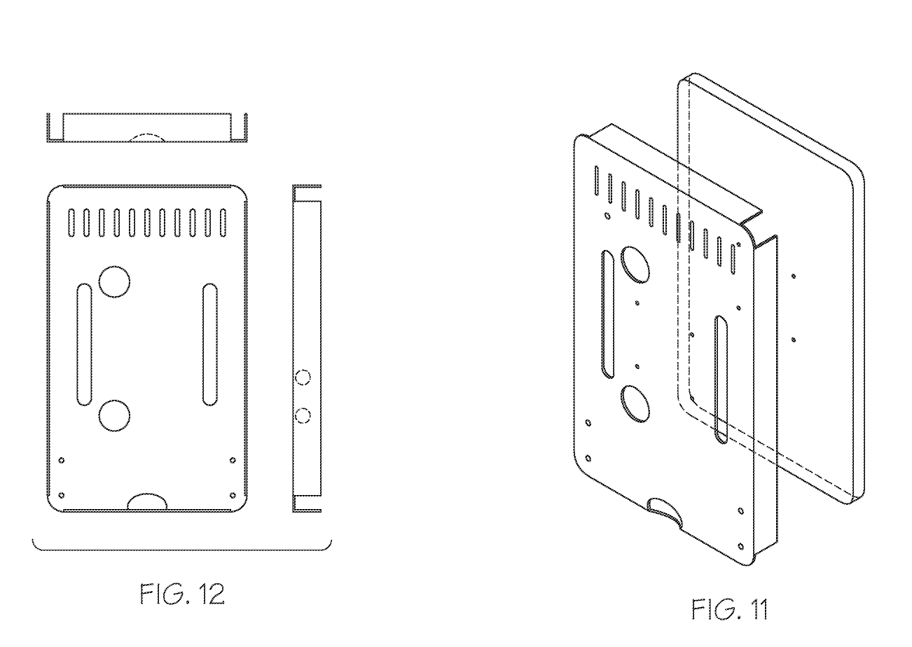

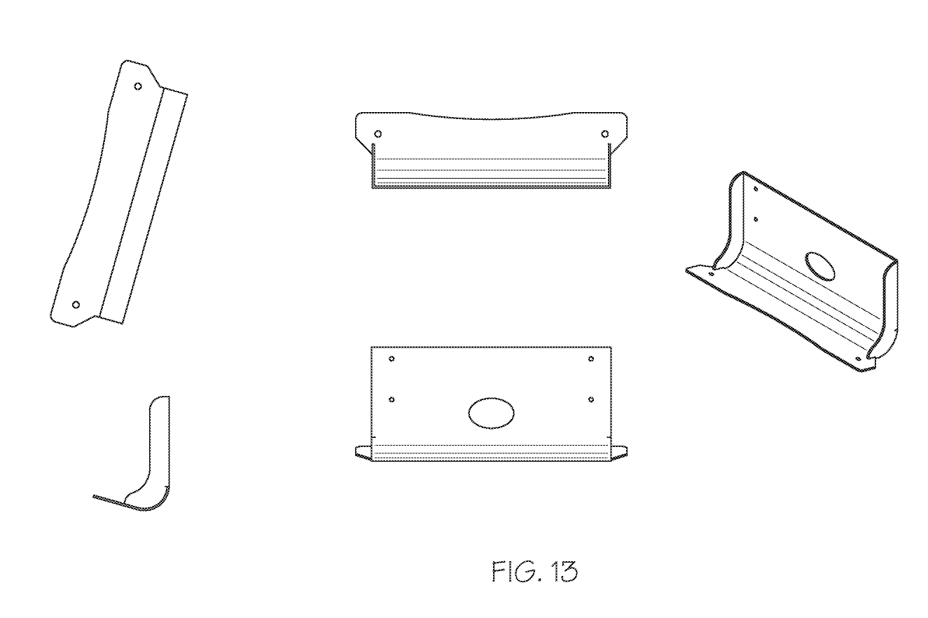

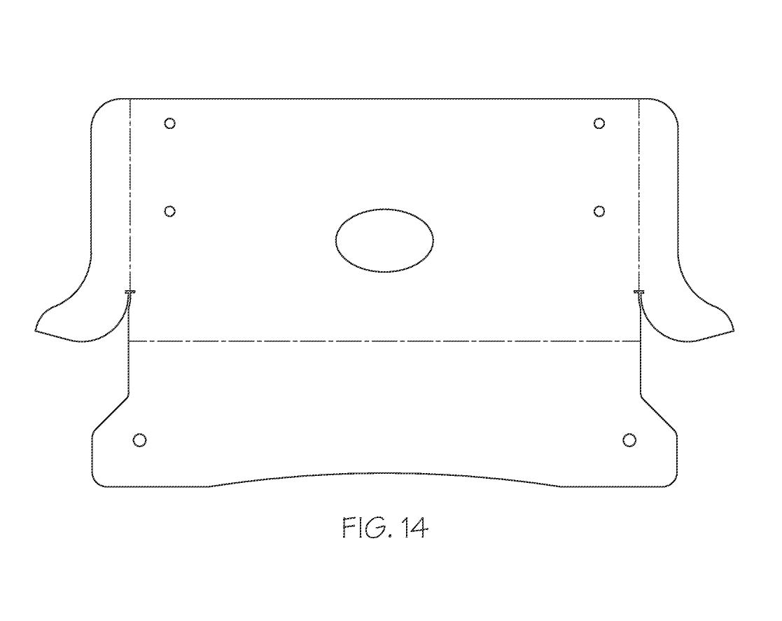

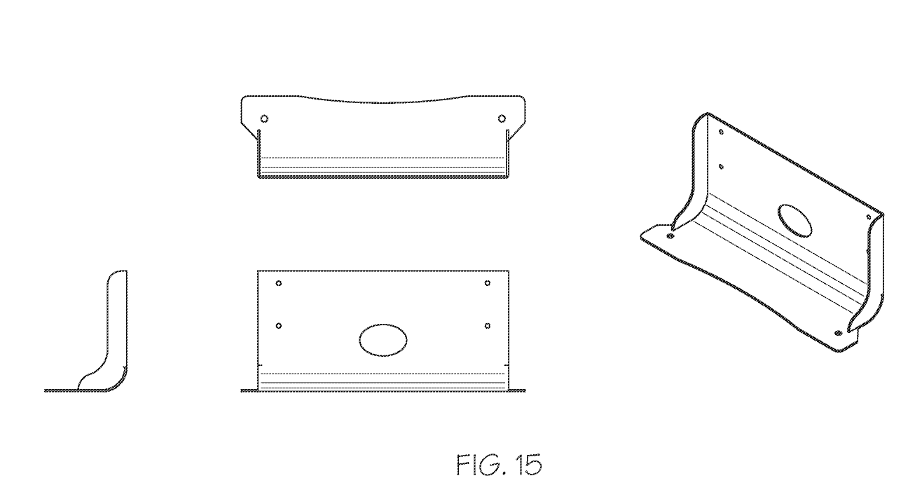

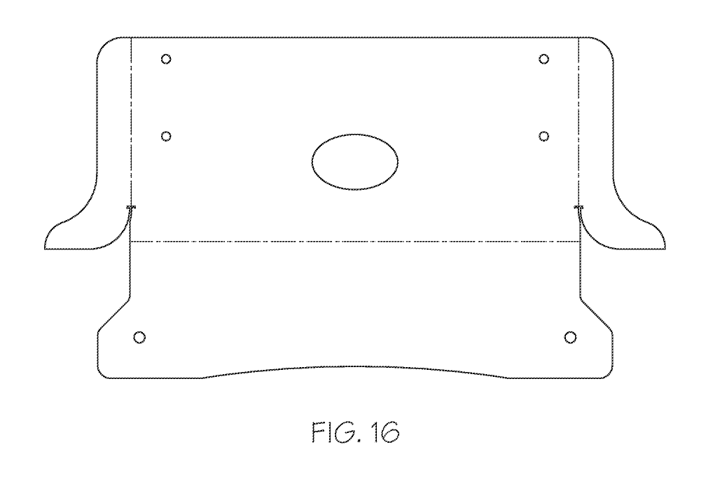

The digital advertising video display unit shown in FIG. 1 is a touch screen computer 10 which is attached to the top of an ATM 12. The display unit is electrically connected to the ATM and piggy-backs off the ATM's internet connection to stream digital advertising content to the display unit. The display unit can be attached to a variety of brackets 14 which position it vertically for the different angles of various ATM brands.

The digital advertising video display can be easily updated whenever advertising changes via the internet, and will cycle through its advertising content in a continuous loop.

The digital advertising unit can display a header 16 and footer 18, which can be a scrolling news display, the weather, or whatever desired, while the main display cycles through the advertising content.

The interactive software could also allow the user to obtain an electronic coupon for a local business. The user would input their email address or smartphone number and the electronic coupon would be sent either to an email address or texted to the smartphone.

OMNi XP Gen3 Digital Advertising Media Display Unit (D.A.V.D.U.), often referred to as an ATM ‘digital topper’, is a 22″ portrait rounded touch screen encased in a hard case steel jacket component that marries with a bracket footer 20 that works with the exact ATM model that the unit is mounted on top of.

The OMNi XP DAVDU is supported by HD resolution graphics and dual speaker sound and is managed through an internet protocol wireless or wired connection so that content running on the DAVDU can be managed from a secured portal on any web browser. The DAVDU is powered by standard 220 v electrical source that is modified by an external power supply that plugs into a standard outlet.

Varying types of content can run on the DAVDU platform including video, motion graphics, still images and RSS feed data such as weather, stock tickers, date, time and more. Exclusive to the DAVDU is our winning lottery powerball ticket number feeds.

Within the Gen3 DAVDU, there is an additional feature as an option that includes a high definition Bluetooth beacon that recognizes a proprietary mobile app that is built to download directly to the user's mobile device so that coupons, advertisements, rich content and deals can be offered as a loyalty-based program when in proximity to the beacon.

Additionally, the DAVDU touch screen can be used to engage customers to interact with the DAVDU to get access to specific deals or coupons offered on the DAVDU screen. These offers, when touched are delivered to the user's mobile phone using SMS mobile text technology. The DAVDU touch screen may also be used for other purposes to access other interactive content on the DAVDU that may or may not push data to the user's mobile device.

What is claimed is:

1. A digital advertising video display unit in combination with a kiosk, the kiosk having an internet connection, the digital advertising video display unit being connected to the kiosk internet connection, so that the advertising display content can be updated via the internet connection.

2. The digital advertising video display unit of claim 1, wherein the kiosk is an ATM machine.

3. The digital advertising video display unit of claim 2 wherein the display unit is mounted to the ATM with a bracket which positions the display unit in a vertical position.

4. The digital advertising video display unit of claim 3 wherein the display unit includes a computer to drive a touch screen and speakers.

5. The digital advertising video display unit of claim 4 including interactive software to allow a user to conduct an electronic transaction selected from the group consisting of making a restaurant reservation, purchasing a movie ticket, purchasing a concert ticket and purchasing an electronic lottery ticket.

6. The digital advertising video display unit of claim 5 wherein the interactive software periodically polls a server to determine if advertising content needs to be updated.

7. The digital advertising video display unit wherein the display unit is approximately 21 inches high and approximately 13 inches wide.

8. The digital advertising video display unit of claim 6 wherein the interactive software can provide a user an electronic coupon.

9. The digital advertising video display unit of claim 1 further including a Bluetooth beacon that is configured to download directly to a user's mobile device so that coupons, advertisements, rich content and deals can be offered as a loyalty-based program when in proximity to the beacon.

10. The digital advertising video display unit of claim 1 wherein the internet connection is wired.

11. The digital advertising video display unit of claim 1 wherein the internet connection is wireless.
